(19) United States
(12) Patent Application Publication
(10) Pub. No.: US 2020/0408914 A1
(43) Pub. Date: Dec. 31, 2020

(54) STATIC SIX DEGREE-OF-FREEDOM PROBE

(71) Applicant: FARO Technologies, Inc., Lake Mary, FL (US)

(72) Inventor: John M. Mountney, Philadelphia, PA (US)

(21) Appl. No.: 16/894,125

(22) Filed: Jun. 5, 2020

Related U.S. Application Data
(60) Provisional application No. 62/866,852, filed on Jun. 26, 2019.

(51) Int. Cl. G01S 17/66; G01S 17/42; G01B 11/00; G01C 15/00

(52) U.S. Cl. CPC G01S 17/66; G01C 15/002; G01B 11/005; G01S 17/42

(57) ABSTRACT

A laser tracker measures three-dimensional (3D) coordinates of three non-collinear retroreflectors of a six degree-of-freedom (six-DOF) probe. A processor coupled to the laser tracker determines an orientation angle of the six-DOF probe based at least in part on the measured 3D coordinates of the three retroreflectors.

### CROSS REFERENCE TO RELATED APPLICATIONS

This application claims the benefit of U.S. Provisional Application Ser. No. 62/866,852 filed Jun. 26, 2019, the entire disclosure of which is incorporated herein by reference.

### BACKGROUND

The present disclosure relates to a coordinate measuring device and particularly a coordinate measuring device capable of measuring six degrees of freedom. One set of coordinate measurement devices belongs to a class of instruments that measure the three-dimensional (3D) coordinates of a target point such as a retroreflector target. The instrument may determine the coordinates of the target point by measuring a distance and two angles to the target. The distance is measured with a distance-measuring device such as an absolute distance meter or an interferometer. The angles are measured with an angle-measuring device such as an angular encoder. The beam may be steered with a gimbaled mechanism, a galvanometer mechanism, or other mechanism.

A laser tracker is a coordinate-measuring device that tracks the retroreflector target with one or more beams it emits, which may include light from a laser or non-laser light source. Coordinate-measuring devices closely related to the laser tracker are the total station. A total station is a 3D measuring device most often used in surveying applications. It may be used to measure the coordinates of diffusely scattering or retroreflective targets. Hereinafter, the term laser tracker is used in a broad sense to include total stations and dimensional measuring devices that emit laser or non-laser light.

In many cases, a laser tracker sends a beam of light to a retroreflector target. A common type of retroreflector target is a spherically mounted retroreflector (SMR), which comprises a cube-corner retroreflector embedded within a metal sphere. The cube-corner retroreflector includes three mutually perpendicular mirrors. The vertex, which is the common point of intersection of the three mirrors, is located at the center of the sphere. Because of this placement of the cube corner within the sphere, the perpendicular distance from the vertex to any surface of the SMR remains constant, even as the SMR is rotated. Consequently, the laser tracker can measure the 3D coordinates of a surface by following the position of an SMR as it is moved over the surface. Stating this another way, the laser tracker measures three degrees of freedom (one radial distance and two angles) to characterize the 3D coordinates of a surface.

One type of laser tracker contains only an interferometer (IFM) without an absolute distance meter (ADM). If an object blocks the path of the laser beam from one of these trackers, the IFM loses its distance reference. The operator must then track the retroreflector to a known location to reset to a reference distance before continuing the measurement. A way around this limitation is to put an ADM in the tracker. The ADM can measure distance in a point-and-shoot manner, as described in more detail below. Some laser trackers contain only an ADM without an interferometer.

A gimbal mechanism within the laser tracker may be used to direct a laser beam from the tracker to the SMR. Part of the light retroreflected by the SMR enters the laser tracker and passes onto a position detector. A control system within the laser tracker uses position of the light on the position detector to adjust the rotation angles of the mechanical axes of the laser tracker to keep the beam of light centered on the SMR. In this way, the tracker can follow (track) a moving SMR.

Angle measuring devices such as angular encoders are attached to the mechanical axes of the tracker. The one distance measurement and two angle measurements of the laser tracker are enough to specify a three-dimensional location of the SMR.

Some laser trackers can measure six degrees-of-freedom (six-DOF), rather than the ordinary three degrees-of-freedom. One such six-DOF tracker sends a beam of light to a retroreflector on a six-DOF probe while capturing with a camera on the tracker emitted points of light on the six-DOF probe.

Although six-DOF laser trackers and six-DOF probes are generally suitable for their intended purpose, some limitations exist in the expense and accuracy of systems that use such devices. What is needed is a laser tracker having the ability to measure the six degrees-of-freedom of a probe for lower cost and with greater accuracy.

### SUMMARY OF THE INVENTION

According to an embodiment, a probe comprises: a body; and three non-collinear retroreflectors coupled to the body.

In addition to one or more of the features described herein, or as an alternative, further embodiments of the probe may include the three non-collinear retroreflectors are cube-corner retroreflectors. In addition to one or more of the features described herein, or as an alternative, further embodiments of the probe may include the cube-corner retroreflectors being embedded within a spherically mounted retroreflector. In addition to one or more of the features described herein, or as an alternative, further embodiments of the probe may include a tactile probe having a probe tip. In addition to one or more of the features described herein, or as an alternative, further embodiments of the probe may include the probe being further affixed to a robot end-effector.

According to another embodiment, a method comprises: with a laser tracker, measuring three-dimensional (3D) coordinates of three non-collinear retroreflectors of a six degree-of-freedom (six-DOF) probe; with a processor, determining an orientation angle of the six-DOF probe based at least in part on the measured 3D coordinates of the three retroreflectors; and storing the orientation angle.

In addition to one or more of the features described herein, or as an alternative, further embodiments of the method may include determining, with the processor, each of three orientation angles of the six-DOF probe, the determined three orientation angles based at least in part on the measured 3D coordinates of the three retroreflectors. In addition to one or more of the features described herein, or as an alternative, further embodiments of the method may include further determining, with the processor, a position of the six-DOF probe based at least in part on the measured 3D coordinates of at least one of the three retroreflectors.

In addition to one or more of the features described herein, or as an alternative, further embodiments of the method may include coupling the six-DOF probe to an end-effector of a robot. In addition to one or more of the features described herein, or as an alternative, further embodiments of the method may include directing, with the processor, the movement of a robot based at least in part on the measured 3D coordinates of the three non-collinear retroreflectors.

In addition to one or more of the features described herein, or as an alternative, further embodiments of the method may include, in a first instance, with the processor, directing the robot to move to a plurality of poses; in the first instance, with the laser tracker, obtaining compensation information by measuring 3D coordinates of the three non-collinear retroreflectors at each of the plurality of poses; and in a second instance, with the processor, commanding the robot to move to a commanded pose, the processor further correcting the commanded pose to account for the obtained compensation information.

In addition to one or more of the features described herein, or as an alternative, further embodiments of the method may include the three non-collinear retroreflectors being included in spherically mounted retroreflectors (SMRs), the SMRs being coupled to the six-DOF probe with kinematic nests, each kinematic nest permitting the SMR it holds to be rotated without changing a center of the SMR it holds. In addition to one or more of the features described herein, or as an alternative, further embodiments of the method may include each kinematic nest further having a magnet that holds the SMR in place against the kinematic nest. In addition to one or more of the features described herein, or as an alternative, further embodiments of the method may include rotating one of the SMRs in its kinematic nest between the first instance and the second instance.

According to a further embodiment, a method comprises: with a laser tracker, measuring three-dimensional (3D) coordinates of three non-collinear retroreflectors of a six degree-of-freedom (six-DOF) probe; with a processor, determining 3D coordinates of a probe tip of a tactile probe affixed to the six-DOF probe; and storing the 3D coordinates.

These and other advantages and features will become more apparent from the following description taken in conjunction with the drawings.

### BRIEF DESCRIPTION OF THE DRAWINGS

Referring now to the drawings, exemplary embodiments are shown which should not be construed to be limiting regarding the entire scope of the disclosure, and wherein the elements are numbered alike in several FIGURES:

FIG. 1A is an isometric view of a laser tracker and a retroreflector target in accordance with an embodiment;

FIG. 1B is a front view of a laser tracker according to an embodiment;

FIGS. 2A, 2B are front and section views, respectively, of a payload assembly according to an embodiment;

FIGS. 3A, 3B, 3C are top, exploded, and isometric views on an SMR according to an embodiment;

FIG. 4A is a six-DOF probe according to an embodiment;

FIG. 4B is an isometric view of a laser tracker measuring the six degrees-of-freedom of a six-DOF probe by sending beams of light from the tracker to retroreflectors on the probe according to an embodiment;

FIGS. 5A, 5B are top and front views of a six-DOF probe according to an embodiment;

FIGS. 5C, 5D are top and front views of a six-DOF probe following rotation about a z axis according to an embodiment;

FIGS. 6A, 6B are top and front views of a six-DOF probe according to an embodiment;

FIGS. 6C, 6D are top and front views of a six-DOF probe following rotation about an x axis according to an embodiment;

FIGS. 7A, 7B are front views of a six-DOF probe before and after rotation, respectively, about ay axis according to an embodiment;

FIG. 8 is an isometric view of a six-DOF probe mounted to an end effector of a robot according to an embodiment;

FIG. 9 is an isometric view of an alternative six-DOF probe used in conjunction with SMRs according to an embodiment; and

FIG. 10 is an isometric view of a robot having the alternative six-DOF probe affixed to an end effector according to an embodiment.

### DETAILED DESCRIPTION

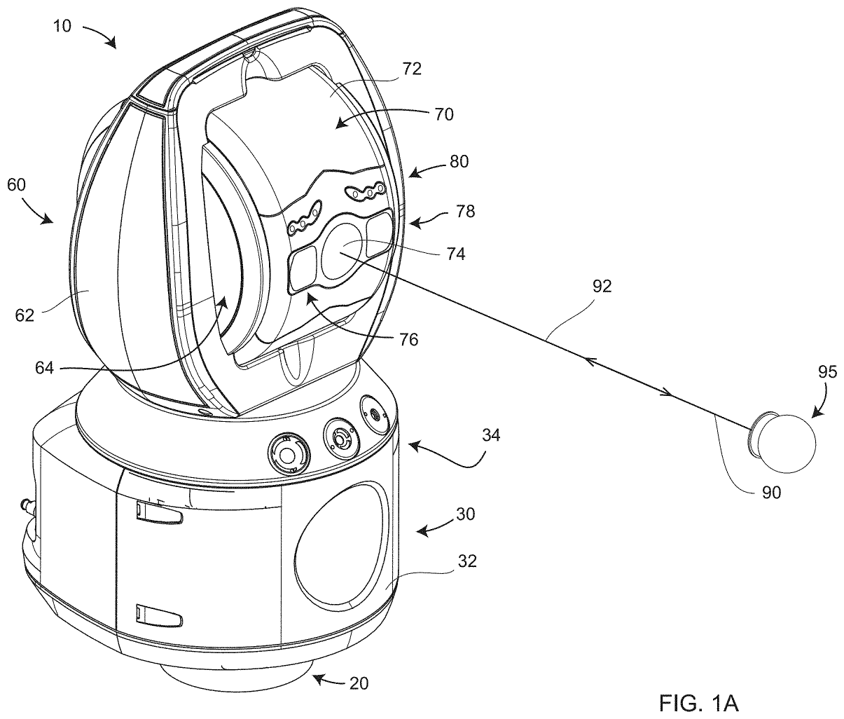

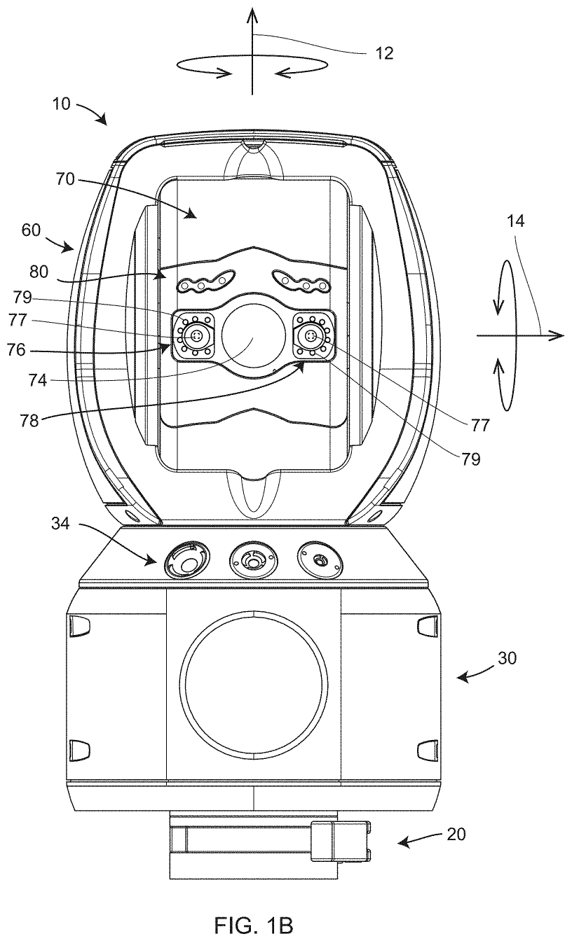

An element, such as laser tracker 10, is shown in FIG. 1A. Although element 10 is referred to as a laser tracker, it may be more generally considered a 3D coordinate measuring device. As explained in the introduction, the term laser tracker is here used to refer to laser tracker in a general sense and may include a total station or 3D measuring device. As further explained herein above, a laser tracker may also launch light from a superluminescent diode, a light emitting diode (LED), or another light source.

The laser tracker 10 in FIGS. 1A, 1B sends outgoing light 90 through an exit aperture 74 to a retroreflector 95, which returns the light along a parallel path as returning light 92, which passes a second time through the exit aperture 74. The laser tracker 10 includes a base assembly 30, a yoke assembly 60, and a payload assembly 70. An outer portion of the payload assembly 70 includes payload assembly covers 72, a first locator camera 76, a second locator camera 78, and payload indicator lights 80. In an embodiment, the indicator lights may shine green to indicate found target, red to indicate measuring, and blue or yellow for user-definable or six-DOF indications. An outer portion of the yoke assembly 60 includes yoke-assembly covers 62 and yoke indicator lights 64. Yoke indicator lights 64 may advantageously be seen at large distances from the tracker. An outer portion of the base assembly 30 includes base-assembly covers 32 and home-position nests 34 include a magnet operable to hold SMRs of different diameters. In an embodiment, three magnetic home-position nests 34 accept SMRs having diameters of 1.5 inches, 0.875 inch, and 0.5 inch. A mandrel 20 may optionally be attached to a lower portion of the laser tracker 10 for use in conveniently attaching the laser tracker 10 to an instrument stand.

FIG. 1B shows a front view of the laser tracker 10. The base assembly 30 is ordinarily stationary with respect to a work area, for example, being mounted on an instrument stand or an industrial tripod. The yoke assembly 60 rotates about an azimuth axis 12, sometimes referred to as a standing axis or a vertical axis, although it should be appreciated that the laser tracker 10 may, in general, be positioned upside down or be rotated to an arbitrary angle with respect to a floor. The payload assembly 70 rotates about a zenith axis 14, sometimes referred to as a transit axis or a horizontal axis. FIG. 1B shows the locator cameras 76, 78 with cover windows removed so that the camera photosensitive arrays 77 and infrared LEDs 79 are visible. In an embodiment, the infrared LEDs 79 periodically flash infrared light. Illuminated retroreflectors within the environment are imaged by the locator cameras 76, 78, placing images of the illuminated retroreflectors on the photosensitive arrays 77.

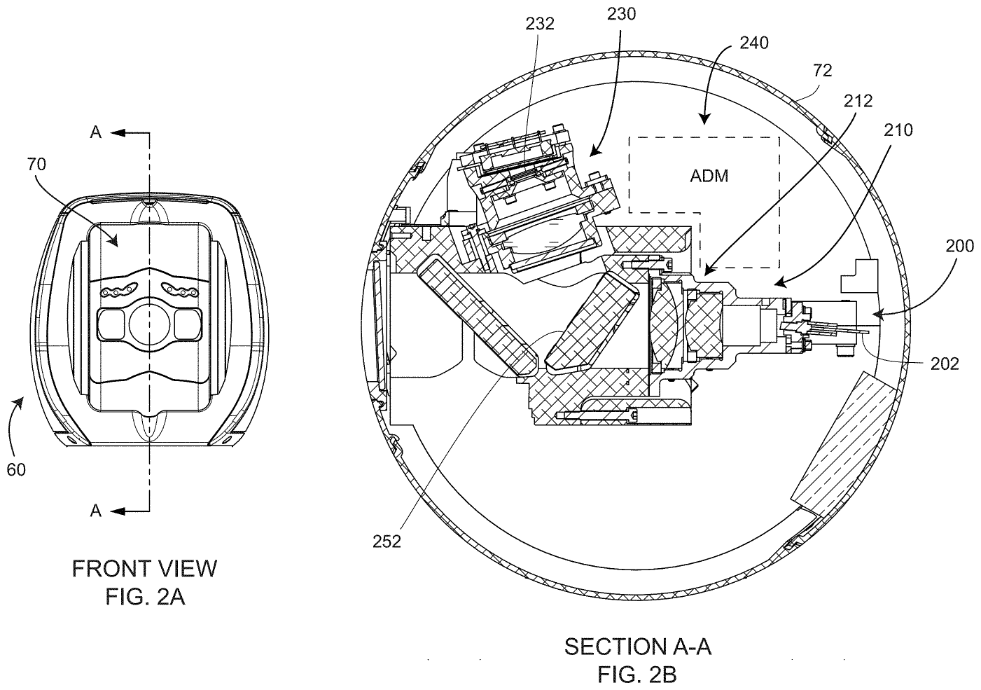

FIG. 2A is a front view of the payload assembly 70 and an upper portion of the yoke assembly 60. FIG. 2B is a cross-sectional view A-A showing optical elements within the payload assembly 70. Optical elements placed mainly along a central portion of the payload assembly 70 are referred to as a central-optics assembly 200, which includes a launch-collimator assembly 210 and a position-detector assembly 230. Outside the central-optics assembly 200 is an ADM module 240.

In an embodiment, light from an optical fiber 202 launches from a small spot having a diameter of a few micrometers and diverges to meet collimator lens elements 212 within the launch-collimator assembly 210. The position-detector assembly 230 includes a position detector 232, which is a detector that converts light into electrical signals and further provides secondary electrical signals that enable determination of a position at which light strikes a surface area of the position detector 232. Examples of position detectors include a lateral effect detector, a quadrant detector, a complementary metal-oxide-semiconductor (CMOS) array, and a charge-coupled detector (CCD).

The position-detector assembly 230 is ordinarily used to keep the beam of outgoing light 90 centered or nearly centered on a moving retroreflector 95, thereby causing the beam of returning light 92 to follow the same path as the beam of outgoing light 90. A small portion of light returning from the retroreflector 95 is reflected off beam splitter 252 into the position-detector assembly 230. A control system causes the tracker motor to steer the beam to keep moving the beam toward the center of the position detector, causing tracking of the retroreflector 95 with the laser tracker 10. In practice, when the outgoing beam is exactly centered on a retroreflector, the returning beam may fall a little off a center of the position detector 232. The position on the position detector of the return beam when the outgoing beam is centered on the retroreflector is referred to as the beam-retrace position.

In an embodiment, the launch-collimator assembly 210 receives a first light through a first optical fiber, launces it into free space, and collimates the launched first light into a first beam of light. In an embodiment, the launch-collimator assembly 210 is further coupled through a first optical fiber to a distance meter such as the ADM module 240, which is operable to measure a distance to a retroreflector 95 illuminated by the beam of outgoing light 90.

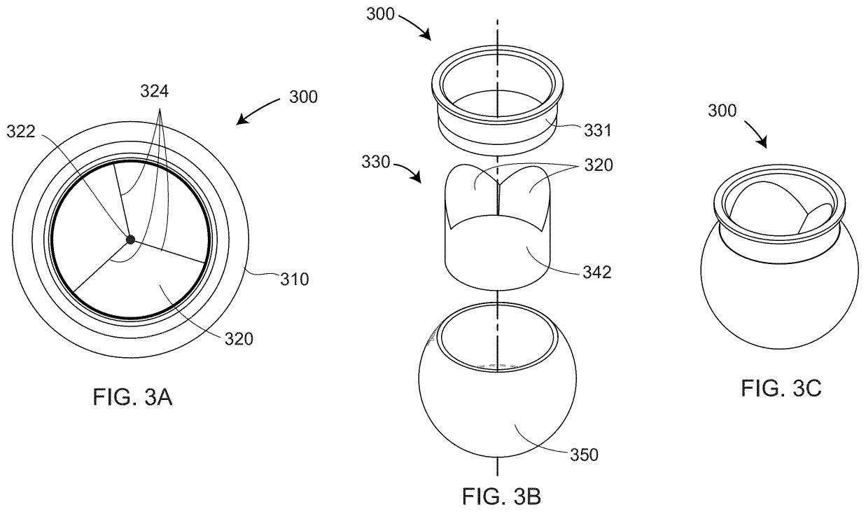

FIG. 3A shows a top view of an SMR 300. The SMR 300 includes three mutually perpendicular reflecting surfaces 320 that intersect in intersection lines 324 and that come together at a vertex 322. In an embodiment, the outer spherical element 310 of the SMR is constructed of ferromagnetic stainless steel. FIG. 3B shows one possible method of constructing an SMR. In an embodiment the SMR 300 includes the steel sphere 350 into which a cylindrical region is bored. A replicated cube-corner retroreflector 330 is created starting with a machined element 342 having surfaces close to those desired in the final cube-corner retroreflector. The surfaces of the machined element are coated with epoxy and then precisely placed onto a negative master coated with a reflective material such as gold. When the epoxy dries, the replicated retroreflector 330 is removed, leaving the three reflective surfaces 320. The SMR 300 is capped with a protective collar 331. An isometric view of the SMR 300 is shown in FIG. 3C.

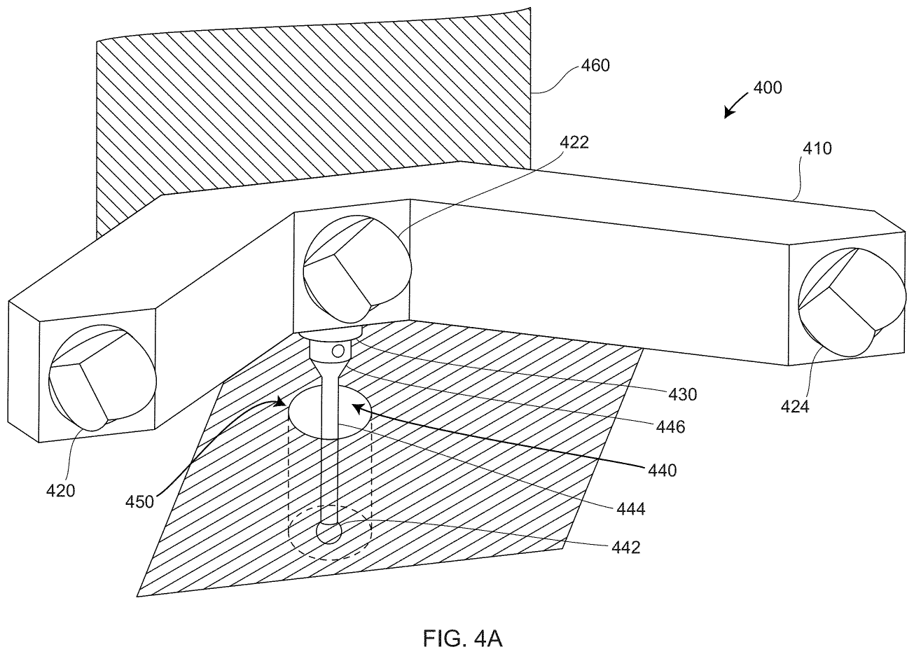

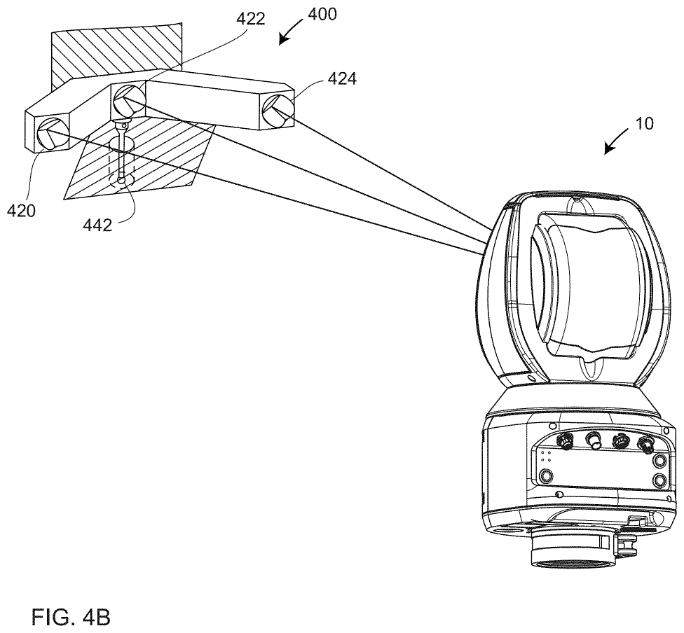

FIG. 4A is an isometric view of a static six-DOF probe 400. In an embodiment, the six-DOF probe 400 includes a frame 410, a first retroreflector 420, a second retroreflector 422, and a third retroreflector 424. In some embodiments, additional retroreflectors are included. In an embodiment, the retroreflectors 420, 422, 424 are replicated cube-corner retroreflectors such as the replicated cube corner retroreflector 330 shown in FIG. 3B. In an embodiment, the six-DOF probe 400 further includes an attachment 430 for connecting to a tactile probe assembly 440. In an embodiment, the tactile probe assembly 440 includes a probe tip 442, a stylus shaft 444, and a mounting fixture 446. In an embodiment, use of tactile probes is optional, and tactile probe assemblies 440 of many lengths and probe tip diameters may be interchangeably attached. In the illustration of FIG. 4A, the six-DOF probe 400 is used to measure characteristics of a hole 450 such as hole depth, hole diameter, and so forth. In an embodiment, one side of the six-DOF probe 400 rests stationary against a surface 460, which might be, for example, the side of a moveable block.

FIG. 4B is an isometric illustration of a laser tracker 10 measuring the retroreflectors 420, 422, 424 of the six-DOF probe 400. The laser tracker sequentially measures the 3D coordinates x, y, z of the vertex of each of the retroreflectors 420, 422, 424 while the six-DOF probe 400 is stationary. These measured coordinates are enough to determine the position of the probe tip 442. The measured coordinates are also enough to determine the three orientation angles (such as the pitch, roll, and yaw angles) of the six-DOF probe 400.

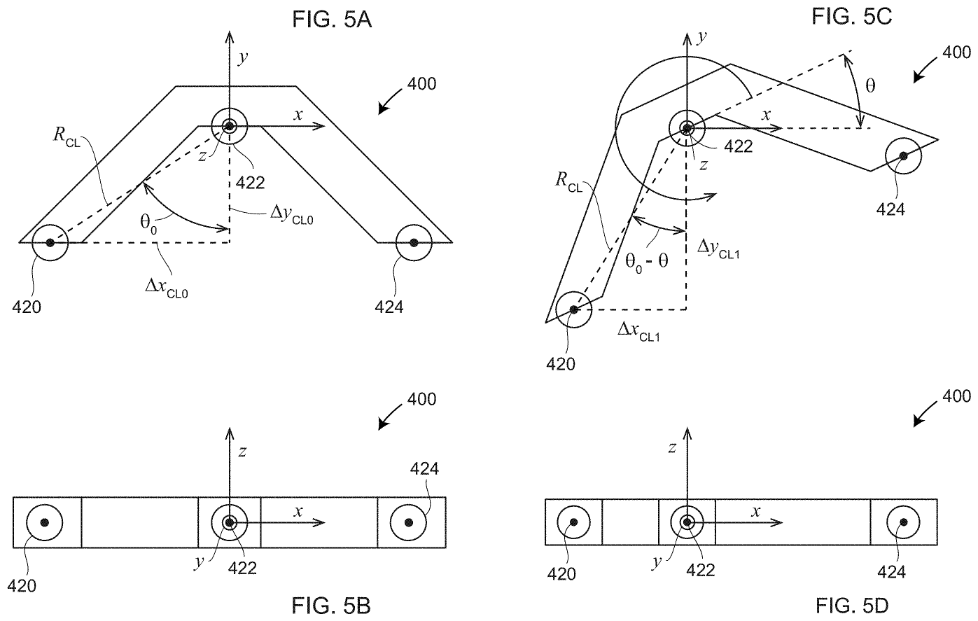

FIGS. 5A, 5B show schematic representations of top and front views, respectively, of a static six-DOF probe 400 in a first pose, the six-DOF probe 400 having retroreflectors 420, 422, 424. The term “pose” as used here means the six degrees of freedom that describe position and orientation. The six-DOF probe 400 is shown relative an x, y, z coordinate system with the origin located at the vertex of the retroreflector 422. In this example, the x-y plane is parallel to the floor, and the z axis points upward. FIGS. 5C, 5D show schematic representations of top and front views, respectively, of the static six-DOF probe 400 in a second pose rotated about the z axis by an angle θ.

In an embodiment, the retroreflectors 420, 422, 424 are non-collinear, with the six-DOF probe 400 aligned relative to the tracker to make the tracker highly sensitive to rotations of the six-DOF probe 400 about the x, y, and z axes. FIGS. 5C, 5D illustrate the case of rotation of the six-DOF probe 400 about the z axis by the angle θ. For the case of the tracker viewing the six-DOF probe 400 in a front view, with the probe having an appearance to the tracker as that given in FIG. 5B or 5D, the tracker is sensitive to rotation of the six-DOF probe 400 about the z axis either using angle measurements (e.g., using angular encoders) or using radial distance measurements (e.g., using an ADM or IFM), or both. Let the distance between the vertices of retroreflectors 420, 422 of FIGS. 4A, 4B be R_{CL}. The change in distance between the retroreflectors 420, 422 before and after rotation is R_{CL}[sin(θ₀−θ)−sin(θ₀)] in the x direction and R_{CL}[cos(θ₀−θ)−cos(θ₀] in the y direction. For the tracker viewing the six-DOF probe 400 in a front view, the accuracy of the x measurements may depend largely on the accuracy of the angle measuring devices (e.g., angular encoders) within the tracker, and the accuracy of the y measurements depend largely on the accuracy of the distance measuring devices (e.g., ADM, IFM) within the tracker. Because the initial angle θ₀ is not very close to either 0 degrees or 90 degrees, there is a relatively large change in both the x and y readings of the tracker as a result of the rotation and both the angle and distance measuring systems of the tracker contribute to accurately determining the value of the angle θ. These same arguments may be applied to the angles calculated using the retroreflectors 422 and 424. Rotation about the z axis is sometimes referred to as a “yaw” rotation.

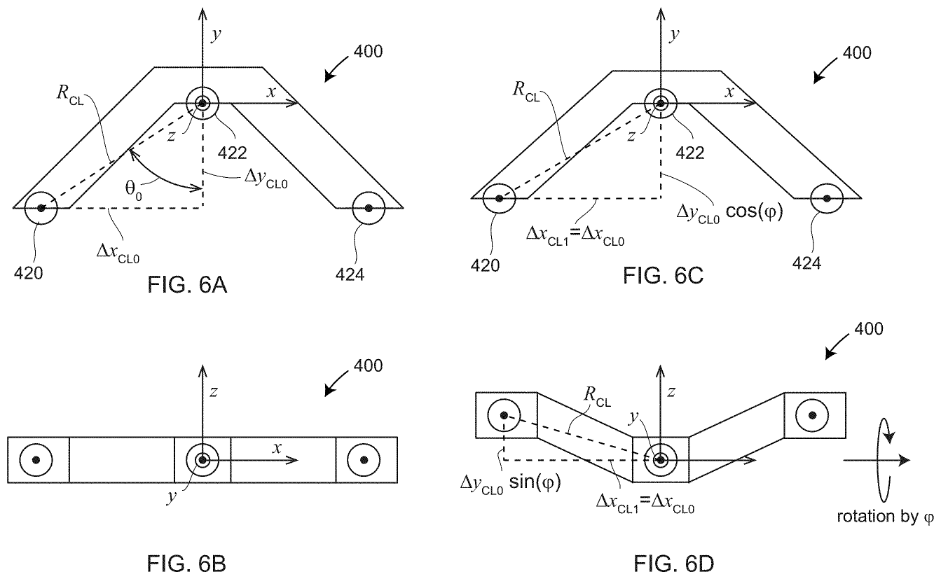

A rotation about the x axis in FIG. 6B is commonly referred to as “pitch” rotation. FIGS. 6A, 6B show schematic representations of top and front views, respectively, of a static six-DOF probe 400 in the first pose previously illustrated in FIGS. 5A, 5B. FIGS. 6C, 6D show schematic representations of top and front views, respectively, of the static six-DOF probe 400 rotated about the x axis by an angle φ. The changes in the y and z lengths as a result of the rotation by the angle φ are shown in FIGS. 6C, 6D. As shown in FIGS. 6A, 6C, the change in the y distance between the first retroreflector 420 and the second retroreflector 422 is equal to Δy_{CL1}(1−cos(φ)). As shown in FIGS. 6B, 6D, the change in the z length is Δy_{CL0} sin(φ). For the laser tracker 10 viewing the six-DOF probe 400 in or near the front view of FIG. 6B or FIG. 6D, the change in the y length resulting from the rotation φ is relatively insensitive to changes in the angle φ since 1−cos(φ) is a small number when φ is small. On the other hand, the change in the z length resulting from the rotation φ is proportional to sin(φ) and is consequently relatively sensitive to change φ. Since the relatively highly accurate angular encoders of the tracker are available to measure the change in the z length, it follows that the pitch angle φ can be determined to relatively high accuracy with the laser tracker 10.

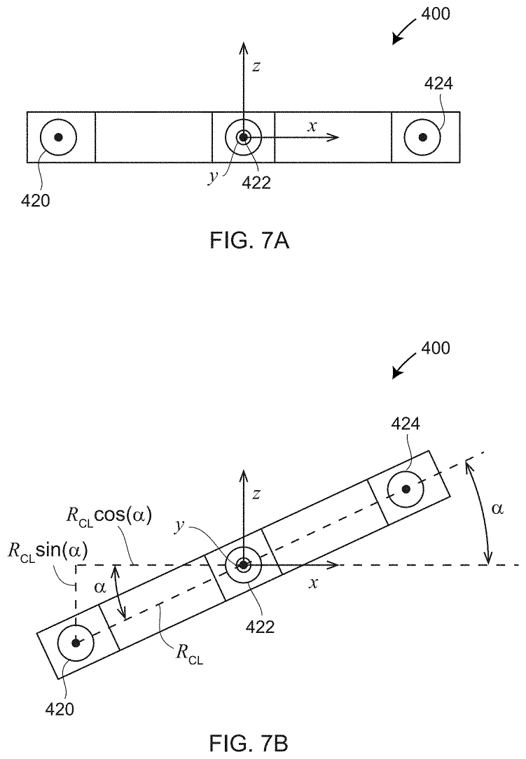

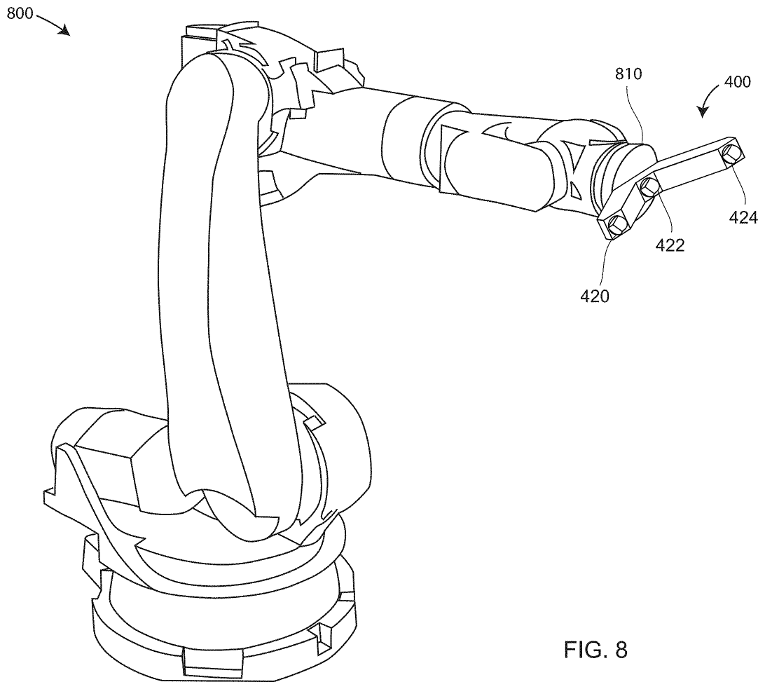

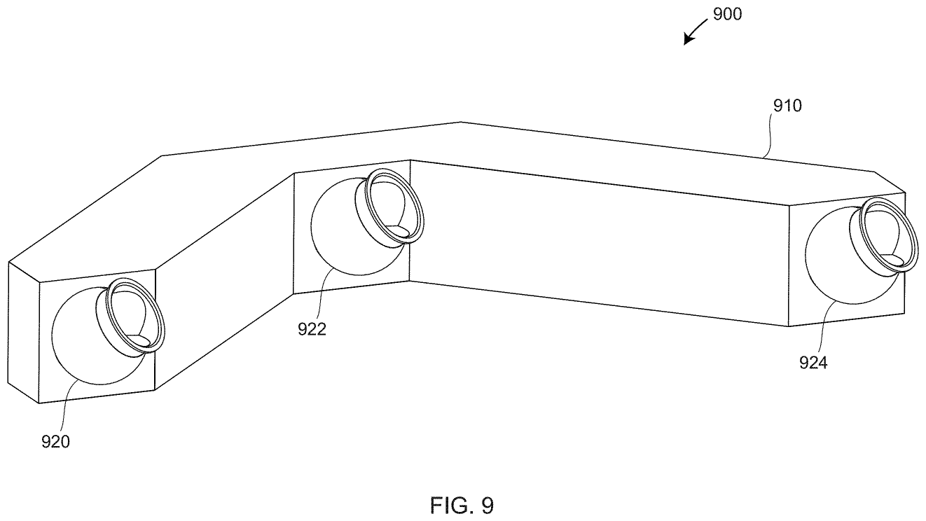

FIG. 7A shows a schematic representation of a front view of the six-DOF probe 400. A rotation about the y axis by an angle α in FIG. 7B is commonly referred to as “roll” rotation. The sensitivity to the roll angle α is relatively good for all values of α.

In contrast to the approach for determining pitch, yaw, and roll angles described in relation to FIGS. 5A, 5B, 5C, 5D, 6A, 6B, 6C, 6D, 7A, 7B, consider an alternative approach in which the retroreflectors 420, 422, 424 are collinear. In this case, the angles measured by the angular encoders would not be very helpful in determining the pitch and yaw angles. In this case, highly accurate measurements of the pitch and yaw angles would be difficult or impossible to obtain.

FIG. 8 shows the six-DOF probe 400 attached to the end-effector 810 of a robot 800. There are several ways in which the six-DOF probe 400 may be advantageously used when attached to the end-effector 810. In an embodiment, a laser tracker 10 is used to measure the coordinates of the retroreflectors 420, 422, 424 of the six-DOF probe 400 as the robot 800 exercises its moving components to cover a range of positions and orientations. By comparing measured values of the positions and orientations of the end-effector 810 to the commanded pose (position and orientation), a processor can construct a compensation table that may be used to more accurately drive the end effector to desired positions and orientations. A procedure for collecting such compensation information is referred to as compensation or calibration. Corrections may be made, for example, based on a look up table or by a correction equation. After a calibration (compensation) table or equation has been obtained, the six-DOF probe 400 may be removed from the end-effector 810 and the positions directly corrected based on the table or equation. Alternatively, the six-DOF probe 400 may be left attached to the end effector with the tracker measuring the positions of the retroreflectors 420, 422, 424 measured directly to determine the pose (position and orientation) of the end effector. This latter procedure may be used when it is desired to accurately determine the pose of the end effector while reducing or minimizing drift effects increasingly seen with increased time from the compensation (calibration) procedure. This direct measurement procedure for determining robot pose may also be used when a compensation (calibration) procedure has not been performed on the robot 800.

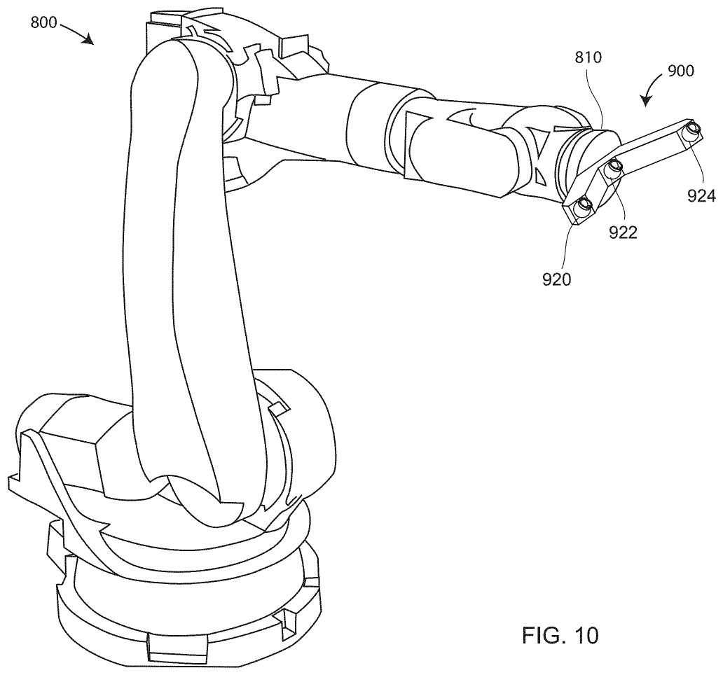

FIG. 9 shows a six-DOF probe 900 according to an alternative embodiment. In an embodiment, the six-DOF probe 900 includes a frame 910, a first SMR 920, a second SMR 922, and a third SMR 924. In some embodiments, additional SMRs are included. In an embodiment, the SMRs 920, 922, 924 are like the SMR 300 FIG. 3C. In an embodiment, the SMRs are held in place by magnetic home-position nests 34 such as the magnetic home-position nests 34 shown in FIGS. 1A, 1B but hidden from view in FIG. 9. In an embodiment, the centers of the SMRs 920, 922, 924 remain fixed in position as the SMRs 920, 922, 924 are rotated within the magnetic nests. A nest that provides such a capability is referred to as a kinematic nest. A common way to make such a kinematic nest is to place contact points that are kept in contact with the spherical surface of the SMR as the SMR is rotated within the nest. A potential advantage of the six-DOF probe 900 over the six-DOF probe 400 is that the SMRs in FIG. 9 may be rotated to any desired direction, while the retroreflectors 420, 422, 424 in FIG. 4A remain fixed in orientation. The acceptance angle of a cube-corner retroreflector 420 is typically around 25 or 30 degrees, which means that a robot end-effector 810, when rotated too far in one direction or another, will outside the field-of-view of a laser tracker 10 that is following the retroreflectors, at least without moving the laser tracker.

FIG. 10 shows a six-DOF probe 900 affixed to the end-effector 810. In this case, the SMRs 920, 922, 924 may be rotated to keep the SMRs within the field-of-view of a tracker that is following their movement.

In some embodiments, the six-DOF probe, such as the six-DOF probe 400 or 900, have more than three retroreflectors or SMRs. In an embodiment, the six-DOF probe includes four retroreflectors or SMRs, the four retroreflectors or SMRs advantageously arranged to be non-coplanar.

Terms such as processor, controller, computer, digital signal processor (DSP), a field programmable gate array (FPGA) are understood in this document to mean a computing device that may be located within an instrument, distributed in multiple elements throughout an instrument, or placed external to an instrument.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but only as limited by the scope of the appended claims.

What is claimed is:

1. A probe comprising:
a body; and
three non-collinear retroreflectors coupled to the body.

2. The probe of claim 1 wherein the three non-collinear retroreflectors are cube-corner retroreflectors.

3. The probe of claim 2 wherein the cube-corner retroreflectors are embedded within a spherically mounted retroreflector.

4. The probe of claim 1 further comprising a tactile probe having a probe tip.

5. The probe of claim 1 wherein the probe is further affixed to a robot end-effector.

6. A method comprising:
with a laser tracker, measuring three-dimensional (3D) coordinates of three non-collinear retroreflectors of a six degree-of-freedom (six-DOF) probe;
with a processor, determining an orientation angle of the six-DOF probe based at least in part on the measured 3D coordinates of the three non-collinear retroreflectors; and
storing the orientation angle.

7. The method of claim 6 further comprising:
with the processor, determining each of three orientation angles of the six-DOF probe, the determined three orientation angles based at least in part on the measured 3D coordinates of the three retroreflectors.

8. The method of claim 7 further comprising:
with the processor, further determining a position of the six-DOF probe based at least in part on the measured 3D coordinates of at least one of the three retroreflectors.

9. The method of claim 6 further comprising coupling the six-DOF probe to an end-effector of a robot.

10. The method of claim 9 further comprising:
with the processor, directing a movement of a robot based at least in part on the measured 3D coordinates of the three non-collinear retroreflectors.

11. The method of claim 9 further comprising:
in a first instance, with the processor, directing the robot to move to a plurality of poses;
in the first instance, with the laser tracker, obtaining compensation information by measuring 3D coordinates of the three non-collinear retroreflectors at each of the plurality of poses; and
in a second instance, with the processor, commanding the robot to move to a commanded pose, the processor further correcting the commanded pose to account for the obtained compensation information.

12. The method of claim 11 wherein the three non-collinear retroreflectors are included in spherically mounted retroreflectors (SMRs), the SMRs being coupled to the six-DOF probe with kinematic nests, each kinematic nest permitting the SMR it holds to be rotated without changing a center of the SMR positioned on the kinematic nest.

13. The method of claim 12 wherein each kinematic nest further includes a magnet that holds the SMR in place against the kinematic nest.

14. The method of claim 13 further comprising rotating one of the SMRs in its kinematic nest between the first instance and the second instance.

15. A method comprising:
with a laser tracker, measuring three-dimensional (3D) coordinates of three non-collinear retroreflectors of a six degree-of-freedom (six-DOF) probe;
with a processor, determining 3D coordinates of a probe tip of a tactile probe affixed to the six-DOF probe; and
storing the 3D coordinates.
